(19) United States
(12) Patent Application Publication
(10) Pub. No.: US 2002/0104332 A1
(43) Pub. Date: Aug. 8, 2002

(54) Method and device for producing a quartz glass body

(76) Inventors: Klaus Ruppert, Maintal (DE); Wolfgang Krock, Erlensee (DE); Peter Kleinsorge, Gelnhausen (DE); Uwe Christiansen, Gelnhausen (DE)

Correspondence Address: Andrew L Tiajoloff, 330 Madison Avenue, New York, NY, 10017, US

(21) Appl. No.: 10/018,142

(22) PCT Filed: Apr. 9, 2001
(86) PCT No.: PCT/EP01/01035

(30) Foreign Application Priority Data
Apr. 14, 2000 (DE) 100 18 857.5

(51) Int. Cl. C03B 37/018

(52) U.S. Cl. 65/421; 65/531

(57) ABSTRACT

In a known procedure for manufacture of a quartz glass body, a glass starting material and fuel gas are fed to a rotationally symmetrical deposition burner (1) having several annular gap nozzles (7-9) and being formed by coaxial arrangement of a number of quartz glass tubes (2-5), such glass starting material in a burner flame forming SiO₂ particles which, under back and forth motion of the deposition burner (1) along the longitudinal axis of a rotating mandrel (12), are deposited on such rotating mandrel under formation of an essentially cylindrical porous blank. To enable replacement of such deposition burner without major efforts in terms of work and costs, the procedure of the invention proposes to use a deposition burner (1) the annular gap nozzles (7-9) of which have gap widths with a maximum dimensional deviation of 0.1 mm, and that the deposition burner (1) is co-axially encompassed and aligned in a given direction of space by means of an alignment unit (27; 32) engaging the burner's outer surface (35), and that the alignment unit (27; 32) is connected to a shifting device (28) for positioning the former within a horizontal plane. In a suitable device for implementation of this procedure, a deposition burner (1) is manufactured to possess annular gap nozzles (7-9) with gap width deviations of no more than 0.1 mm, the outer surface (35) of such burner being coaxially engaged by an alignment unit (27; 32) capable of rotating at least in a first plane and connected to a shifting unit (28) capable of being positioned within a second horizontal plane (FIG. 2).

The present invention relates to a procedure for the manufacture of a quartz glass body, in which the glass starting material and the fuel gas are fed to a rotationally symmetrical deposition burner with several annular gap nozzles such being formed by coaxial arrangement of several quartz glass tubes, such glass starting material in a burner flame forming SiO₂ particles which, under back and forth motion of the deposition burner along the longitudinal axis of a rotating mandrel, are deposited on such rotating mandrel under formation of an essentially cylindrical porous blank.

The invention also relates to a device for implementation of such procedure which consists of a rotationally symmetrical deposition burner with several annular gap nozzles such burner being formed by coaxial arrangement of several quartz glass tubes and connected to a holding facility.

In the manufacture of quartz glass bodies according to the so-called OVD procedure (outside vapor deposition), one or several deposition burners are used to deposit SiO₂ particles on the outer surface of a rotating mandrel effectively forming a cylindrical porous quartz glass blank (hereinafter also referred to as “soot body”). Such deposition burners usually are made of quartz glass or metal with quartz glass deposition burners being advantageous in that contamination of the quartz glass body by abrasion can be largely avoided.

A quartz glass burner of this type is known from DE-A1 195 27 451. The burner described therein consists of quartz glass tubes in a concentric arrangement forming a central nozzle and a total of three annular gap nozzles. The starting material, SiCl₄, and the fuel gases, hydrogen and oxygen, are supplied to the central and the external annular gap nozzles, respectively. Situated between the central and the external nozzles is a separation gas nozzle through which an oxygen flow is supplied, which initially separates the SiCl₄ flow from the fuel gas flow. The separation gas nozzle tapers off in the direction of the nozzle orifice, and thus has a focussing effect on the separation gas.

The manufacture of the known quartz glass burner follows the traditional principles of the glass-making industry with certain limits on the attainable dimensional accuracy. Every quartz glass burner is unique and as a consequence the process parameters of the OVD procedure need to be adapted to the characteristics of the deposition burner(s) used. Upon replacement of a quartz glass burner it is commonly observed that essential properties of the quartz glass body are changed, e.g. the green density or the distribution of the doping agent, so that the process parameters must be adapted to the new quartz glass burner at great expense of time and material. This is most apparent upon replacement of one deposition burner out of a series of burners arranged into a burner group, as the individual characteristics of the neighboring separation burners also become influential.

Accordingly, the invention relates to the task of providing a procedure for the manufacture of a quartz glass body by means of one or several quartz glass burners, in which the burners can be replaced both easily and inexpensively, and to devise a suitable device for implementation of this procedure.

This task is solved in the invention on the basis of the afore-mentioned procedure by using a burner with annular gap nozzles, the gap widths of which show dimensional deviation of no more than 0.1 mm, such burner being held by an alignment unit engaging the outside surface of the burner, and being pointed in a predefined direction in space, and by such alignment unit being connected to a shifting unit for positioning the alignment unit within a horizontal plane.

The procedure according to the invention consists of three different, mutually interdependent measures:

1. Provision of a deposition burner with defined dimensional accuracy, in that the dimensional accuracy of the gap widths of the annular gap nozzles does not exceed 0.1 mm;

2. alignment of the deposition burner in a predefined direction in space by means of an alignment unit engaging the outside surface of the burner and thus providing for accurate guidance of burner alignment;

3. positioning of the deposition burner in a predefined position by shifting the alignment unit in a horizontal plane.

The invention is based on the notion that only through combining said measures the technical task at hand can be solved. Simply providing for the required dimensional accuracy of the deposition burner is insufficient to solve the problem, unless the burner is aligned by means of an alignment unit engaging on the outside of the burner, and reproducibly positioned. Similarly, exact alignment and reproducible positioning of a quartz glass burner are insufficient to solve the problem unless the dimensional accuracy of the gap width of the annular gap nozzles corresponds at least to the required value.

The gap width of an annular gap nozzle arranged between two adjacent coaxial glass tubes is defined as the distance between the external wall of the inner quartz glass tube and the internal wall of the outer quartz glass tube. The dimensional deviation of the gap width is defined as the difference between the allowances above and below a nominal gap width value. Deviations from the nominal gap width are the result either of some shape tolerance of the quartz glass tubes (such as diameter and thickness variations and circularity errors) or positional tolerances (such as eccentric arrangement). Each individual annular gap nozzle of a deposition burner must comply with the maximal dimensional accuracy value required above. The stated dimensional accuracy value of 0.1 mm was determined for burners with gap widths between 0.5 and 5 mm. Presumably, less strict dimensional accuracy values may still yield acceptable results with larger gap width burners.

Alignment of the deposition burner may involve rotation of the burner around a rotation axis, whereas the positioning of the burner involves a shifting motion.

Preferably, the deposition burner is aligned by means of an alignment unit consisting of at least two spaced holding elements fitted with one flexible coaxial ring each. The holding elements engage at different points of the burner's outer surface and thus provide for axial guidance of the deposition burner. Because of the coaxial rings being flexible, the deposition burner is not damaged during alignment and variations of the outside diameter of the burner are compensated. The central nozzle of the deposition burner can be utilized as a suitable reference line for alignment.

It is advantageous to measure the coaxial arrangement of the quartz glass tubes on the face of the assembly using a profile projector. The profile projector detects the front faces of the quartz glass tubes forming the deposition burner mouth and thus permits determination of the dimensional accuracy of the annular gap nozzles.

In a further improvement of the procedure, the front faces of the quartz glass tubes are polished effectively removing deposits from the front faces of the quartz glass tubes facing the burner flame and prolonging the serviceable life. Chemical etching—e.g. by immersion in hydrofluoric acid—serves to smooth off edges and improves the gas flow from the part. Mechanical polishing is preferred over flame polishing because of the improved reproducibility of the polishing result.

The procedure of the invention becomes particularly simple to implement, if the deposition burner is first aligned in a vertical direction and then moved by means of the alignment unit into a preferable position below the mandrel such that the longitudinal axis of the deposition burner intersects with the longitudinal axis of the mandrel. This arrangement can be implemented by the use of an auxiliary wire in place of the mandrel along which the burner is then aligned. By definition, the longitudinal axis of the burner coincides with the longitudinal axis of the central burner nozzle. A gauge is used to adjust the distance between the deposition burner and the lower edge of the mandrel.

With respect to a suitable device for implementation of the procedure of the invention, the task stated above is solved on the basis of the device referred to above by designing the annular gap nozzles such that the gap width of the annular gap nozzles does not exceed a max. value of 0.1 mm, and by designing the holding facility as an alignment unit that surrounds the outer surface of the deposition burner in coaxial arrangement and can be rotated around a first and a second swivel axis, and is connected to a positioning unit capable of shifting within a horizontal plane.

The device according to the invention consist of the following three main parts:

1. a deposition burner with defined dimensional accuracy, in that the dimensional accuracy of the gap widths of each of the annular gap nozzles of such deposition burner does not exceed 0.1 mm;

2. an alignment unit that can be rotated around two swivel axes and engages on the outside surface of the burner to provide for accurate guidance of the burner and alignment in a predefined direction of space; and

3. a positioning unit that is connected to the alignment unit and serves to position the deposition burner in a predefined position by shifting the alignment unit within a horizontal plane.

For details on the effect of these parts with regard to the technical task to be solved as well as for definitions of the terms, “gap width” and “dimensional accuracy”, please refer to the explanations of the procedure according to the invention provided above.

It is advantageous to design the alignment unit to consist of at least two spaced holding elements with one flexible coaxial ring each engaging at different points on the outer surface of the burner, thus providing for exact guidance of the deposition burner. Because of the coaxial rings being flexible, the deposition burner is not damaged during alignment and variations of the outside diameter of the burner are compensated.

In a very satisfactory embodiment of the device according to the invention, the front faces of the quartz glass tubes are polished and smoothened by chemical etching. Mechanical polishing is preferred over flame polishing in order to attain high dimensional accuracy. After chemical etching, e.g. with hydrofluoric acid, the edges between the front face and the outer surface of the cylinder have well-defined rounding-off radii.

It is preferable to manufacture the deposition burner from quartz glass tubes cut at a right angle to the longitudinal axis of the tube as this improves the reproducibility of the deposition properties of the burner.

In the following is shown in diagrammatic view in

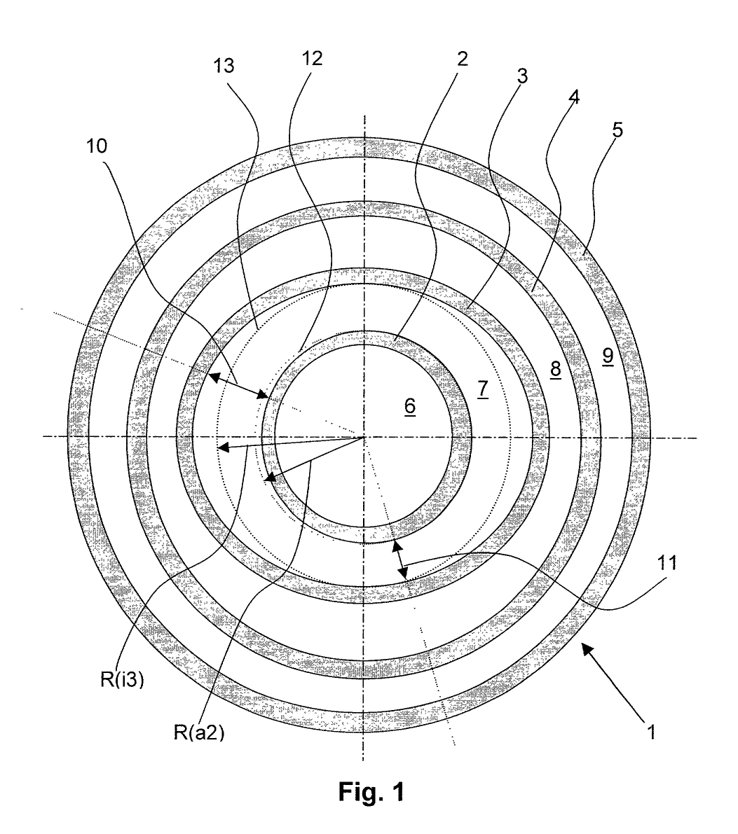

FIG. 1 a top view of the burner mouth of a deposition burner, and in

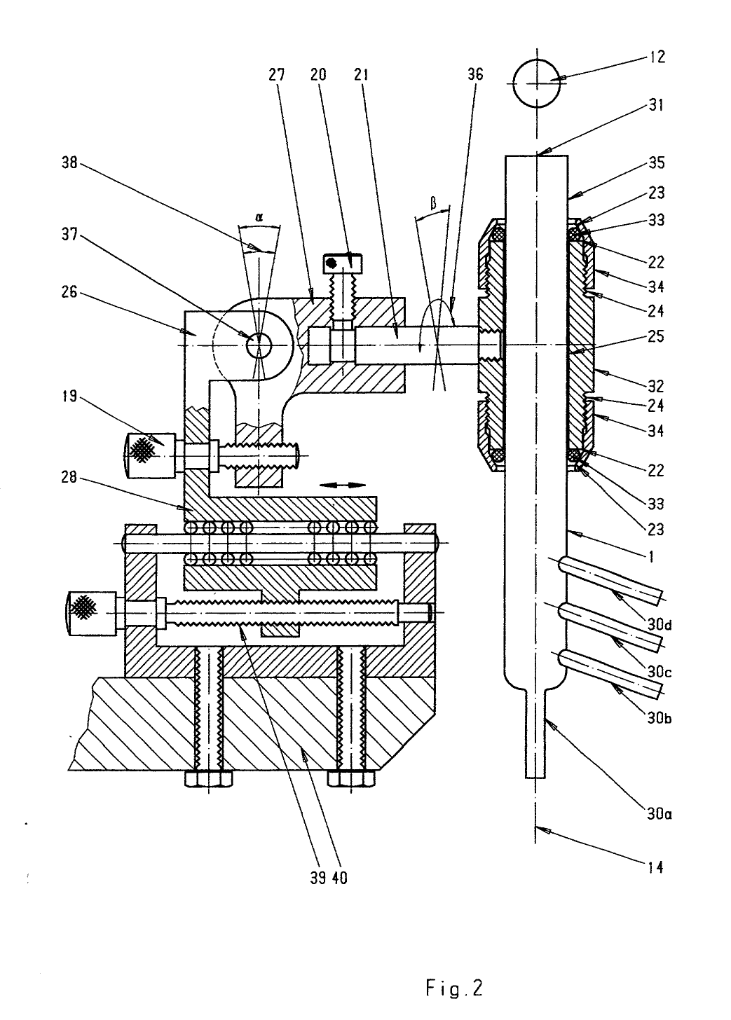

FIG. 2 an embodiment of a device according to the invention.

FIG. 1 serves to illustrate a suitable procedure for the determination of gap widths and dimensional deviations of deposition burners. The schematic depiction shows a top view of the front face of a rotationally symmetrical deposition burner 1. Deposition burner 1 consists of at least four quartz glass tubes 2, 3, 4, 5 in coaxial arrangement. Central quartz glass tube 2 surrounds central nozzle 6; separation gas nozzle 7 is situated between the adjacent quartz glass tubes 2 and 3; quartz glass tubes 3 and 4 surround fuel gas nozzle 8, and quartz glass tubes 4 and 5 surround external nozzle 9.

In the following, separation gas nozzle 7 is used as an example to illustrate the procedure for determination of the dimensional deviation of the gap width. For illustrative purposes, quartz glass tubes 2-5 are depicted with shape and positional errors, e.g. uneven wall thickness, non-circular cross-sections and eccentric arrangement.

The ideal case is denoted by two dotted concentric lines 12 and 13 extending coaxial to longitudinal axis 14 of burner 1. Concentric line 12 with external radius, R_{A2}, surrounds the external wall of quartz glass tube 2, whereas concentric line 13 with internal radius, R₁₃, tangentially touches the inner surface of quartz glass tube 3. Since both concentric lines 12 and 13 are concentric with respect to longitudinal axis 14, the gap width between these lines is constant in all places.

The nominal gap width of separation gas nozzle 7 in the embodiment shown is 0.8 mm. Variations in the wall thickness and diameter as well as eccentricities of the adjacent quartz glass tubes 2 and 3, and eccentric arrangement lead to deviations from the stated nominal gap width. Designation number 10 symbolizes the real maximum gap width and designation number 11 symbolizes the real minimum gap width. The first step in determining the dimensional deviation is to calculate the annular gap width according to the following equation:

S=(internal diameter of outer quartz glass tube 3) minus(outer diameter of inner quartz glass tube 2)

As the two quartz glass tubes each are afflicted by dimensional deviations, extreme tolerance values, Sₘₐₓ (maximal deviation) and Sₘᵢₙ (minimal deviation), are calculated. In the embodiment shown, the maximal value of the internal diameter of quartz glass tube 3 is 4.7 mm+0.05 mm=4.75 mm, whereas the minimal value of the external diameter of quartz glass tube 2 is 3.1 mm−0.05 mm=3.05 mm. From these values, the maximal deviation Sₘₐₓ is calculated: (4.75 mm−3.05 mm)/2=0.85 mm.

Using a similar calculation the minimal value of the internal diameter of quartz glass tube 3 is determined to be 4.7 mm−0.05 mm=4.65 mm, and the maximal value of the external diameter of quartz glass tube 2 to be 3.1 mm+0.05 mm=3.15 mm. From these values, the minimal deviation Sₘₐₓ is calculated to be (4.65 mm−3.15 mm)/2=0.75 mm.

The dimensional accuracy as defined for the purpose of this invention is calculated as the difference of the minimal and maximal deviations:

Sₘₐₓ−Sₘᵢₙ=0.85 mm−0.75 mm=0.1

The dimensional deviations of fuel gas nozzle 8 and external nozzle 9 are then determined accordingly. The dimensional deviation of neither of the annular gap nozzles exceeds the permissible value of 0.1 mm.

FIG. 2 depicts a suitable device for implementation of the procedure according to the invention. The device consists of a deposition burner 1, a swivel table 27 and a shifting table 28.

Deposition burner 1 is a four-nozzle burner as shown in the schematic top view of burner mouth 31 depicted in FIG. 1. Hereinafter, any reference to equivalent components of deposition burner 1 will be made using the designation numbers of FIG. 1.

Deposition burner 1 is essentially rotationally symmetrical about its longitudinal axis 14. The burner consists of four quartz glass tubes 2, 3, 4, 5 in coaxial arrangement with its central nozzle 6 surrounded by three annular gap nozzles (separation gas nozzle 7, fuel gas nozzle 8, and external nozzle 9) in coaxial arrangement. The cross-sections of central nozzle 6, separation gas nozzle 7, fuel gas nozzle 8, and external nozzle 9 correspond to a ratio of 1:5:15:40, respectively.

Each of the nozzles (6-9) is fitted with a gas inlet 30a, 30b, 30c, 30d. The front faces of the upper quartz glass tubes near burner mouth 31 are polished and the edges smoothened by hydrofluoric acid etching.

Deposition burner 1 is suspended in vertical alignment by means of an alignment unit engaging a bracket 32. Bracket 32 has a bore hole 25 through which deposition burner 1 extends. The upper and lower areas of bore hole 25 are designed to have a screw thread each to surround and thus engage deposition burner 1. By screwing a union nut 34 onto screw thread 24 truncated cone-shaped surface 23 on the inside of union nut 34 is pressed against flexible coaxial ring 33 such that this ring is pressed against front face 22 of bracket 32 and outer surface 35 of deposition burner 1. By tightening the two union nuts 34 outer surface 35 of deposition burner 1 is held in centric suspension in two places providing for axial guidance.

Swivel axis 21, extending perpendicular with respect to longitudinal axis 14 and running on bearings on swivel table 28, engages in the center of bracket 32. Rotation around swivel axis 21 causes deposition burner 1 to swivel by swivel angle “β” (designation number 36; perpendicular to the plane shown in the drawing). Locking screw 20 serves to fix swivel axis 21 in position, whereas adjusting screw 19 acting on swivel table 27 facilitates the swivelling of deposition burner 1 around axis 37 by a swivel angle of “α” (designation number 38). Axis 37 connects swivel table 27 to a bearing block 26 attached to a commercial shifting table 28. Spindle 39 provides for linear motion of shifting table 28 which is screwed onto an extension arm 40.

In the following, the procedure of the invention is illustrated on the example of a preform for optical fibers and on the basis of the device shown in FIG. 2:

The first procedural step consists of the manufacture of deposition burner 1 through known methods of the glass-making industry using suitably selected and carefully manufactured quartz glass tubes. Subsequently, the dimensions of burner mouth 31 are measured with a profile projector in order to determine the dimensional deviations of the three annular gap nozzles, as shown in FIG. 1 above. In the embodiment shown, the dimensional deviation values are 0.1 mm, 0.006 mm, and 0.07 mm for the three nozzles proceeding from inside to outside, respectively. Thus, deposition burner 1 complies with the required maximal deviation of gap widths of no more than 0.1 mm for any of the fuel gas nozzles.

Subsequently, deposition burner 1 is lifted up into bore hole 25 and mounted and fixed in bracket 32 such that the arrangement ensures accurate axial guidance of deposition burner 1 by flexible coaxial rings 33 engaging on outer surface 35 of the burner. Through the use of swivel axis 21 and axis 37 deposition burner 1 is aligned such that longitudinal burner axis 14 is in a vertical position.

The fixed and aligned deposition burner 1 is then shifted in a horizontal plane by means of shifting table 27 until longitudinal axis 14 of deposition burner 1 intersects the longitudinal axis of mandrel 12 (in FIG. 2 the longitudinal axis of mandrel 12 runs perpendicular to the plane shown in the drawing).

After manufacture, alignment, and positioning, deposition burner 1 shows unique, but reproducible burner properties. These characteristics are reproduced in a replacement burner replacing deposition burner 1 provided said replacement burner is manufactured, aligned, and positioned in accordance with the procedure of the invention, such that no work- and cost-intensive adjustment of process parameters is required. This also holds true, if deposition burner 1 is one out of a series of deposition burners in a burner group.

To manufacture a GeO₂-doped core layer in accordance with the OVD procedure, soot particles are deposited by moving deposition burner 1 back and forth along mandrel 12, which rotates around its longitudinal axis. For this purpose, SiCl₄, GeCl₄, and carrier gas oxygen are supplied to central nozzle 6 of deposition burner 1. The two starting components (SiCl₄ +GeC₄) and the flow of carrier gas oxygen are supplied at a molar ratio of 1:1. Separation gas oxygen, hydrogen, and fuel gas oxygen are supplied through separation gas nozzle 7, fuel gas nozzle 8, and external nozzle 9, respectively. The four gas flows, i.e. SiCl_{4l +GeCl}₄+carrier gas oxygen, separation gas oxygen, hydrogen, and fuel gas oxygen, are supplied at a volume ratio of 1:1:10:5, respectively.

Once the core layer has grown to the nominal size, a first SiO₂ coat layer is deposited on the core layer. For this purpose, the supply of GeCl₄ to deposition burner 1 is stopped, from whence non-doped SiO₂ particles are deposited under formation of a coating glass layer.

Finally, mandrel 12 is removed and the successively formed green body is cleaned, sintered, and collapsed into a core rod using generally known procedures. To complete the manufacture of the preform for optical fiber production, the core rod is subsequently coated with additional coating glass layers.

1. A method for manufacture of a quartz glass body, in which glass starting material and fuel gas are fed to a rotationally symmetrical deposition burner (1) having several annular gap nozzles (7-9) and being formed by coaxial arrangement of a multitude of quartz glass tubes (2-5), such glass starting material in a burner flame forming SiO₂ particles which, under back and forward motion of the deposition burner (1) along the longitudinal axis of a rotating mandrel (12), are deposited on such rotating mandrel under formation of an essentially cylindrical porous blank, characterized in that a deposition burner (1) is used the annular gap nozzles (7-9) of which have gap widths with a maximum dimensional deviation of 0.1 mm, and that the deposition burner (1) is co-axially encompassed and aligned to a given direction by means of an aligning device (27; 32) gripping its outer surface (35), and that the aligning device (27; 32) is connected to a shifting device (28) which brings the former into a horizontal position.

2. A method according to claim 1, characterized in that the deposition burner is aligned by means of an aligning device (27; 32) having at least two spaced holder elements (34) with one flexible coaxial ring (33) each.

3. A method according to claim 1 or 2, characterized in that the co-axial arrangement of the quartz glass tubes (2-5) is measured at the ends by means of a profile projector, and that the dimensional deviation of the annular gap nozzles (7-9) is determined from the results obtained.

4. A method according to any one of the above claims, characterized in that the quartz glass tubes (2-5) are polished at the ends and then smoothed by chemical etching.

5. A method according to any one of the above claims, characterized in that the deposition burner (1) is vertically aligned by means of the aligning device (27; 32).

6. A method according to claim 5, characterized in that by means of the shifting device (28), the deposition burner (1) is positioned below the mandrel (12) in such a way that the longitudinal axis (14) of the deposition burner (1) intersects the longitudinal axis of the mandrel.

7. A device for realization of the method according to any one of the claims 1 to 6, with a rotationally symmetrical deposition burner (1) having several annular gap nozzles (7-9) and being formed by coaxial arrangement of a multitude of quartz glass tubes (2-5), which is connected to a holder element and characterized in that the annular gap nozzles have a gap width with a maximum dimensional deviation of 0.1 mm, and that the holder element is provided as an aligning device (27; 32) which co-axially encompasses the outer surface (35) of the deposition burner (1) and swivels around a first swiveling axis (21) and a second swiveling axis (37), and which is connected to a horizontally traveling shifting device (28).

8. A method according to claim 7, characterized in that the aligning device (27; 32) has at least two spaced holder elements (34) with one flexible coaxial ring (33) each.

9. A method according to any one of the claims 7 to 9, characterized in that the quartz glass tubes (2-5) are polished at their ends and smoothed by chemical etching.

10. A method according to any one of the claims 7 to 9, characterized in that each end of the quartz glass tubes (2-5) facing a burner flame intersects the longitudinal axis of the tube at right angle.
